(19) United States
(12) Patent Application Publication
(10) Pub. No.: US 2023/0315922 A1
(43) Pub. Date: Oct. 5, 2023

(54) Privacy Data Switch

(71) Applicant: Hewlett-Packard Development Company, L.P., Spring, TX (US)

(72) Inventors: Kuan-Lin Li, Taipei City (TW); Jen-Chun Hsu, Taipei City (TW); Yew-Chung Hung, Taipei City (TW)

(73) Assignee: Hewlett-Packard Development Company, L.P., Spring, TX (US)

(21) Appl. No.: 18/043,901

(22) PCT Filed: Sep. 21, 2020
(86) PCT No.: PCT/US2020/051720

§ 371 Date: Mar. 2, 2023

(51) Int. Cl. G06F 21/85; G06F 21/62; G06F 21/60

(52) U.S. Cl. CPC G06F 21/85; G06F 21/6245; G06F 21/606

(57) ABSTRACT

Various examples described herein relate to a head mountable device (HMD) which comprises an input device to receive captured user data, a connection interface to exchange the user data with a host device, a privacy data switch to route the user data between the input device and the connection interface in the HMD, and a controller. The controller determines whether the user data is restricted data, directs the privacy data switch to block the exchange of the user data when it is determined that the user data is restricted data, and directs the switch to allow the exchange of the user data when it is determined that the user data is not restricted data.

### BACKGROUND

Enhanced reality systems allow a user to become immersed in an enhanced reality environment wherein they can interact with the enhanced environment. Extended reality (XR) technologies include virtual reality (VR), augmented reality (AR), and mixed reality (MR) technologies. XR technologies may use head mounted display (HMDs). An HMD is a display/audio device that may be worn on the head and allow the user to become immersed in a virtual scene. Such HMDs include enhanced reality applications which can provide visual stimuli, auditory stimuli, track user movement, and other user data to create a rich immersive experience.

### BRIEF DESCRIPTION OF THE DRAWINGS

Many aspects of the disclosure can be better understood with reference to the following drawings. While several examples are described in connection with these drawings, the disclosure is not limited to the examples disclosed herein.

FIG. 1 illustrates a block diagram of a head mounted display (HMD) with a privacy data switch, according to an example;

FIG. 2 illustrates a systematic diagram of an HMD with a privacy data switch to exchange user data with an external computing device, according to an example;

FIG. 3 illustrates a system in an HMD with an open universal serial bus (USB) switch to block the exchange of sensor data with a host device;

FIG. 4 illustrates a system in an HMD with a closed USB switch to allow the exchange of sensor data with a host device;

FIG. 5 illustrates a flow diagram of a method of monitoring for a token to allow the exchange of private data between an HMD and a host device, according to some examples; and

FIG. 6 illustrates a block diagram of a non-transitory readable medium storing machine-readable that upon execution cause a system to direct a USB switch to block the exchange of private data with a host device, according to another example.

### DETAILED DESCRIPTION

A head mounted display (HMD) can be employed as an extended reality (XR) technology to extend the reality experienced by the HMD's wearer. An HMD can project images which immerse the wearer of the HMD with virtual reality (VR), augmented reality (AR), mixed reality (MR), or another type of XR technology. An HMD may also include input devices to receive captured user data, such as from sensors, microphones, and cameras. The user data may include biological data, biographical data, video data, voice data, or any other data associated with a user which may be captured using an HMD.

Some user data may be private or have security concerns. For example, a user's name, birthdate, and tracked heartrate may be sensitive information which should be shared with only authorized devices. With the increasing number of input devices (e.g., biosensors) implemented into XR headsets to gather user data, a high level of security in transmitting the user data is needed.

Several techniques for securing user data involve encrypting the user data when exchanging with external computing devices. However, the encrypted data may be intercepted and hacked by unauthorized users during or after transmission. Furthermore, a third party administrator may want to disable certain sensors from being able to transfer captured data to a host device when the user of the HMD is unauthorized or has not subscribed to be able to transfer the sensor data for processing in the host device.

Therefore, a more effective technique for protecting sensitive user information is to ensure that the data is not transmitted out of the HMD unless proper authentication is verified. The HMD may instead utilize a dedicated hardware data transmission switch or valve to block unauthorized data traffic from being exchanged with an external computing device. In particular, the HMD may include specific software to complete the authorization process and enable restricted data to be exchanged with the external computing device using the dedicated hardware data transmission switch.

Various examples described herein relate to an HMD which comprises an input device to receive captured user data, a connection interface to exchange the user data with a host device, a privacy data switch to route the user data between the input device and the connection interface in the HMD, and a controller. The controller determines whether the user data is restricted data, directs the privacy data switch to block the exchange of the user data when it is determined that the user data is restricted data, and directs the switch to allow the exchange of the user data when it is determined that the user data is not restricted data.

In other examples described herein, an HMD which comprises a universal serial bus (USB) hub to receive first USB data and second USB data from an external computing device, a USB data switch to exchange the second USB data between the USB hub and a sensor hub of the HMD, and a microcontroller unit (MCU). The MCU receives the first USB data from the USB hub, identifies a token included in the first USB data which indicates that the transmission of the second USB data is authorized, and directs the USB data switch to open which blocks an exchange of the second USB data between the sensor hub and the USB hub.

In yet another example, a non-transitory computer-readable medium comprises a set of instructions that when executed by a processor, cause the processor to receive universal serial bus (USB) 2.0 data from a USB hub, identify a privacy indication included in the USB 2.0 data which indicates that associated USB 3.0 data is private, and direct the USB data switch to blocks an exchange of the associated USB 3.0 data between a biosensor and the USB hub.

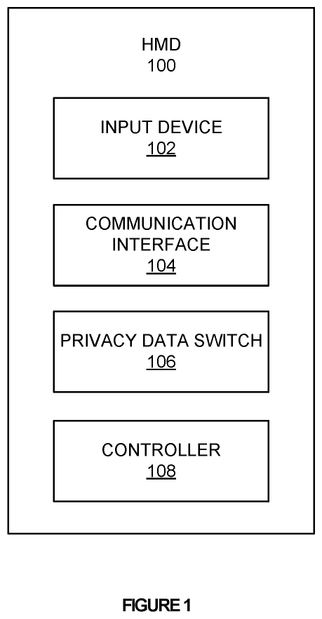

FIG. 1 illustrates a block diagram of an HMD with a privacy data switch, according to an example. The HMD 100 includes an input device 102, a connection interface 104, a privacy data switch 106, and a controller 108. The HMD 100 may be used in a training environment, gaming environment, collaboration environment, or any other XR user experience environment.

The input device 102 may comprise or receive user data from sensors, audio capturing devices, image capturing devices, touch input device, and other comparable devices and associated processing elements capable of receiving inputted user data. In some cases, the input device 102 may be receive the captured user data from devices located externally to the HMD 100, but which interfaces with the input device 102 in the HMD 100 to exchange user data. For example, the input device 102 may receive user data from a hand-hand controller that tracks user gestures and communicates the speed and direction of the user gestures to the HMD 100. In other examples, the input device 102 may receive the user data from a touchpad, keyboard, mouse, or some other device which allows the user to enter information. The user data may then be communicated to the input device 102 in the HMD 100. In other examples, the input device 102 may receive captured user data from sensors, cameras, microphones, etc. which are located internally in the HMD 100.

In some cases, the input device 102 may receive user data from a biometric sensor which can be used to receive user biometric data, such as user behaviors, user motions, user biological data, and the like. For example, an electrocardiogram (EKG) device may monitor a user's heartrate while interacting in an XR environment using the HMD 100. In another example, the biometric sensor may track a user's eye movement or body gestures. It should be noted that various biometric data may be tracked by sensors included in or interfacing with the HMD 100.

In other cases, the input device 102 may receive user data from microphones and/or cameras to receive audio and/or image data associated with the user. The camera and/or microphone may be used to capture data from the external environment which are being received by the user, or data being communicated or viewed by the user themselves. The camera can be a still image or a moving image (i.e., video) capturing device. Examples of the camera include semiconductor image sensors like charge-coupled device (CCD) image sensors and complementary metal-oxide semiconductor (CMOS) image sensors.

The communication interface 104 may include communication connections and devices that allow for communication with other computing systems, such as a host computing device (not shown), over communication networks (not shown). The communication interface 104 may be directed for a target high-end virtual and mixed reality system. For example, a USB type connection may include one or more high speed data traffic lane (i.e., USB 3.0 data traffic lane), and a lower speed data traffic lane (i.e., USB 2.0 data traffic lane).

Further in this example, the communication interface 104 may exchange USB 3.0 data with an external computing device using a USB 3.0 channel and exchange USB 2.0 data with the external computing device using a USB 2.0 channel. Further, the connection interface 104 may include a high-speed multiplexing switch that is capable of switching USB 2 D+/D− signals to redirect/convert USB traffic when there is no USB connection, for example when a VIRTUALLINK® protocol is used. Examples of other connections (i.e., non-USB connections) and devices that together allow for inter-system communication may include network interface cards, antennas, power amplifiers, RF circuitry, transceivers, and other communication circuitry.

The privacy data switch 106 routes data traffic between the HMD 100 device and an external device, such as a host device. In particular, the privacy data switch 106 exchange user data between a hub (not shown) and the input device 102. For example, the hub may include a USB hub which can receive and transfer USB data with a host device over communication interface 104. The USB data exchanged with the host device may include USB 2.0 data and USB 3.0 data. In this example, the privacy data switch 106 may be a USB privacy data switch which can exchange the USB 3.0 data with the USB hub. The USB hub may exchange the USB 2.0 data with controller 108.

The privacy data switch 106 may be able to allow or block the exchange of the user data based on directions received from controller 108. For example, the privacy data switch 106 may comprises a hardware switch physically placed between the USB hub and a sensor hub. When software running on the HMD 100 determines that the USB data include private or secure data, the privacy data switch 106 may physically open or turn off to block the transmission of the private data between the host device and the sensor hub. Conversely, when the software running on the HMD 100 determines that the USB data does not include private data or that the transmission of the private data is authorized, then the privacy data switch 106 may be turned on or closed to allow the user data to pass between the host device and the sensor hub.

The controller 108 determines when user data should be blocked or allowed to be exchanged by the privacy data switch 106. In some examples, the controller 108 comprise a microcontroller unit (MCU). The controller 108 may receive user control data from a host device over communication interface 104. The controller 108 may also receive user control data from a USB hub, such as USB 2.0 data. The user control data may include a token or other authorization data which indicates whether the user data obtained from input device 102 includes private or secure data and whether the exchange of this data is authorized.

In some examples, the controller 108 may receive a first token or authorization indicator from the host device which indicates the initiation of allowing user data to be exchanged or the initiation of blocking the user data from being exchanged between the host device and HMD 100. The controller 108 may then receive a subsequent token or authorization indicator which indicates the termination of the exchange of the user data or the termination of the block of the exchange of the user data between the host device and the HMD 100.

In other examples, the controller 108 may continuously monitor the user data to determine whether the user data should be allowed to be exchanged or blocked. For example, the controller 108 may determine a token in USB 2.0 data for each exchange of the associated USB 3.0 data. If a token is received in the USB 2.0 data which is associated with the USB 3.0 data, then the controller 108 may direct the privacy data switch 106 to allow the associated USB 3.0 data to be exchanged, and vice versa.

Controller 108 include a processing system and/or memory which store instructions to perform particular functions. In particular, controller 108 may be a microcontroller. As used in the present specification and in the appended claims, the term, “microcontroller” refers to various hardware components, which includes a processor and memory. The processor includes the hardware architecture to retrieve executable code from the memory and execute the executable code. As specific examples, the controller as described herein may include computer-readable storage medium, computer-readable storage medium and a processor, an application-specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer-usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the respective component, cause the component to implement at least the functionality described herein.

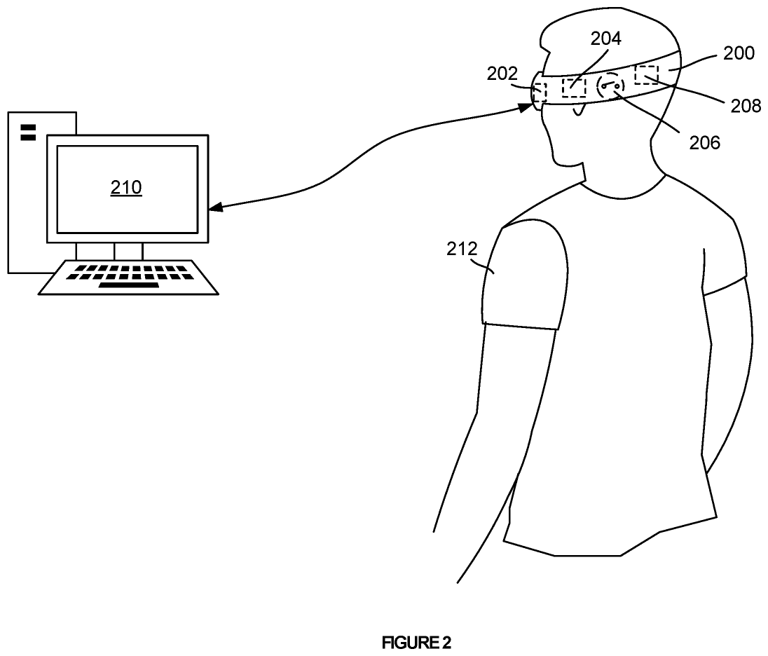

FIG. 2 illustrates an operational diagram of an HMD with a privacy data switch to exchange user data with an external computing device, according to an example. FIG. 2 includes an HMD 200, a host device 210, and a user 212. The HMD 200 may be an example of the HMD 100 from FIG. 1. However, the HMD 200 and the components included in the HMD 200 may differ in form or structure from the HMD 100 and the components included in the HMD 100.

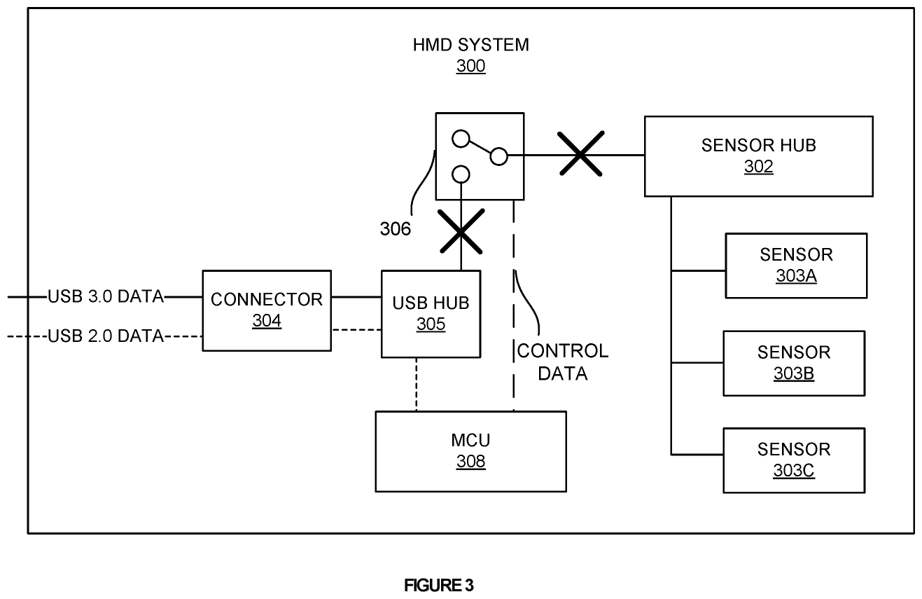

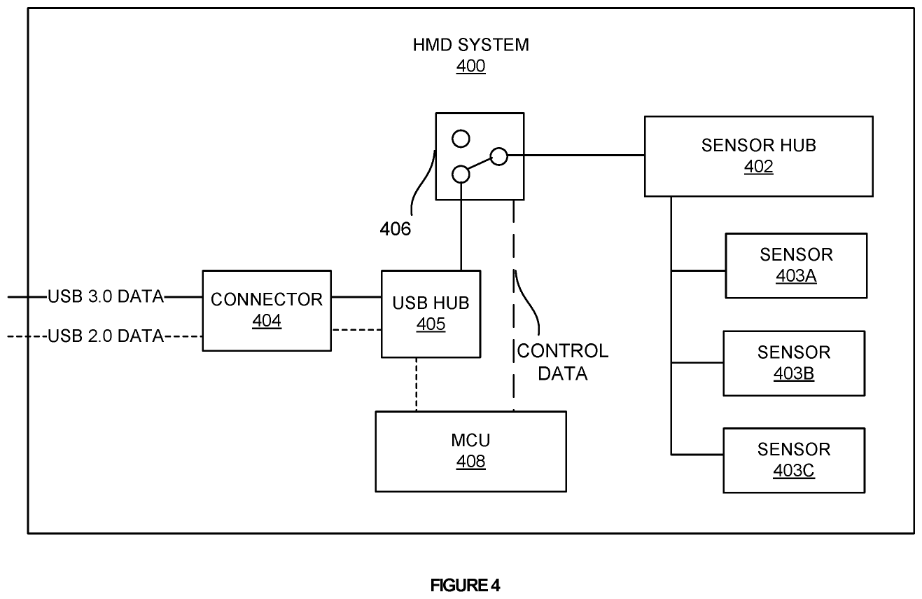

In particular, the HMD 200 includes an input device hub 202, a communication interface 204, a privacy data switch 206, and a microcontroller 208. Although the sensor hub 202, the communication interface 204, the privacy data switch 206, and the microcontroller 208 may be located externally to HMD 200 (see FIG. 3 and FIG. 4). For example, the input device hub 202 may receive user data from a variety of input devices located externally to the HMD 200, such as a watch to track a user's pulse, an external camera to capture user image data, an external microphone to capture user audio data, a touchpad to receive user biographical data, etc. However, input device hub 202 may also receive user data from one or more input devices internal in the HMD 200, such as a camera to track a user's eye-movements.

In operation, the input device hub 202 may receive captured user data from one or more input devices (not shown for clarity). Further, the connection interface 204 may be capable of exchanging the user data with the host device 210. The privacy data switch 206 may be capable of routing the user data between the input device and the connection interface in the HMD.

The microcontroller 208 may be capable of determining whether the user data is restricted data. When the microcontroller 208 determines that the user data is restricted data, the microcontroller 208 directs the privacy data switch 206 to block the exchange of the user data with the host device 210 over the communication interface 204. When the microcontroller 208 determines that the user data is not restricted data, the microcontroller 208 directs the privacy data switch 206 to allow the exchange of the user data with the host device 210 over the communication interface 204. It should be noted that the privacy data switch 206 may block or allow the exchange of the user data which is received from the host device 210 by the HMD 200, or may block or allow the exchange of the user data which is transferred to the user device 210 by the HDM 200.

FIG. 3 illustrates a system in an HMD with an open USB switch to block the exchange of sensor data with a host device. FIG. 3 includes an HMD system 300, a sensor hub 302, sensors 303A-3030, a USB connector 304, a USB hub 305, a USB data switch 306, and an MCU 308. The HMD system 300 may be an example of the HMD 100 from FIG. 1 and/or the HMD 200. However, the HMD system 300 and the components included in the HMD system 300 may differ in form or structure from the HMD 100 and the HMD 200 and the components included therein. It should be noted that in this example scenario, the USB data switch 306 is open and the exchange of data between the sensor hub 302 and the USB hub 305 is blocked (indicated by X's).

FIG. 3 also includes the transmission of USB 2.0 data (indicated by the dotted-lines) and the transmission of USB 3.0 data (indicated by solid-lines). The USB 2.0 data may include a low speed data traffic lane for transferring authorization data associated with the USB 3.0 data. The USB 3.0 data may include high speed data traffic lane for transferring sensor data with a host device. FIG. 3 further includes the transmission of switch control data (indicated by dashed-line) which is transferred from the MCU 308 to the USB data switch 306.

In operation, the USB connector 302 exchanges USB data with a host device. In particular, the USB connector 302 may receive USB 2.0 data which includes an authorization indicator associated with USB 3.0 data. The USB connector 302 also exchanges the USB data with the USB data hub 305. The USB data hub 305 splits the USB data up and sends the USB 2.0 data to the MCU 308 and the USB 3.0 data to the USB data switch 306.

The MCU 308 then processes the authorization information (e.g., presence or absence of a token) in the USB 2.0 data to determine whether the USB data switch 306 should be opened. In this example scenario, the MCU 308 determines that the authorization information in the USB 2.0 data does not authorize the transmission of the sensor information included in the USB 3.0 data from sensor hub 302. In response to determining that the transmission of the sensor data should be blocked, the MCU 308 transfers control data to the USB data switch 306 indicating that the USB data switch 306 should remain open and block the exchange of the sensor data from the sensor hub 302.

FIG. 4 illustrates a system in an HMD with a closed USB switch to allow the exchange of sensor data with a host device. FIG. 4 includes an HMD system 400, a sensor hub 402, sensors 403A-403B, a USB connector 404, a USB hub 405, a USB data switch 406, and an MCU 408. The HMD system 400 may be an example of the HMD 100 from FIG. 1, the HMD 200, and/or the HMD system 300. However, the HMD system 400 and the components included in the HMD system 400 may differ in form or structure from the HMD 100, the HMD 200, and the HMD system 300 and the components included therein.

FIG. 4 also includes the transmission of USB 2.0 data (indicated by the dotted-lines) and the transmission of USB 3.0 data (indicated by solid-lines). The USB 2.0 data may include a low speed data traffic lane for transferring authorization data associated with the USB 3.0 data. The USB 3.0 data may include high speed data traffic lane for transferring sensor data with a host device. FIG. 4 further includes the transmission of switch control data (indicated by dashed-line) which is transferred from the MCU 408 to the USB data switch 406.

In operation, the USB connector 402 exchanges USB data with a host device. In particular, the USB connector 402 may receive USB 2.0 data which includes an authorization indicator associated with USB 3.0 data. The USB connector 402 also exchanges the USB data with the USB data hub 405. The USB data hub 405 splits the USB data up and sends the USB 2.0 data to the MCU 408 and the USB 3.0 data to the USB data switch 406.

The MCU 408 then processes the authorization information (e.g., presence or absence of a token) in the USB 2.0 data to determine whether the USB data switch 406 should be closed. In this example scenario, the MCU 408 determines that the authorization information in the USB 2.0 data does authorize the transmission of the sensor information included in the USB 3.0 data from sensor hub 402. In response to determining that the transmission of the sensor data should be allowed to be exchanged, the MCU 408 transfers control data to the USB data switch 406 indicating that the USB data switch 406 should be closed and allow the exchange of the sensor data from the sensor hub 402.

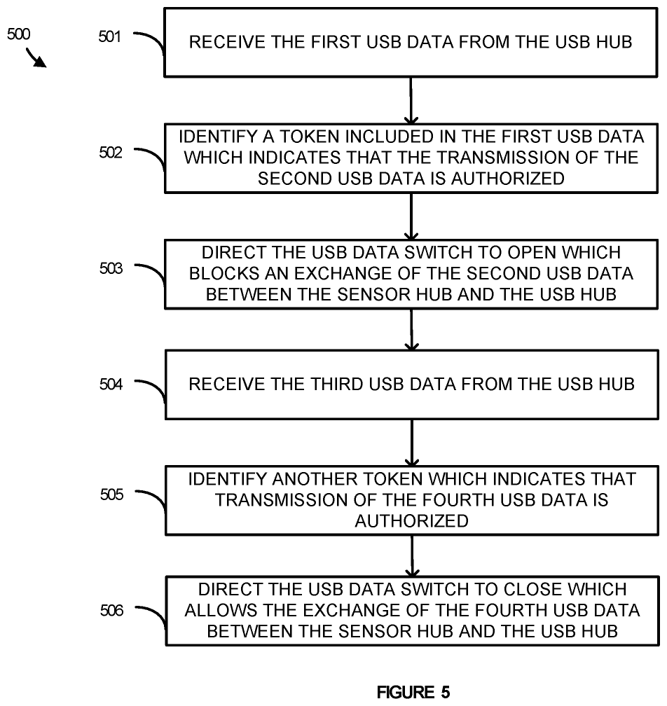

FIG. 5 illustrates a flow diagram of a method of monitoring for a token to allow the exchange of private data between an HMD and a host device, according to some examples. Method 500 is associated with examples discussed herein with regard to FIGS. 1-4, and details of the operations shown in this method can be found in the related discussion of such examples. Some or all of the blocks of method 500 may be implemented in program instructions in the context of a component or components of an application used to carry out the blocking of transmission of the private data.

Although the flow diagram of FIG. 5 shows a specific order of execution, the order of execution may differ from that which is depicted. For example, the order of execution of two of more blocks shown in succession by be executed concurrently or with partial concurrence. All such variations are within the scope of the present disclosure.

Referring parenthetically to the blocks in FIG. 5, method 500 provides receiving the first USB data from the USB hub, at block 501. For example, a host device may transfer first USB data indicating a token. Thus, method 500 provides identifying a token included in the first USB data which indicates that the transmission of the second USB data is authorized, at block 502. For example, the host device may be an administrator of an application running on an HMD and may indicate that the user of the HMD does not have the authority to transfer sensor data to the host device. In other examples, the host device may be an authorized device which is too insecure to receive the sensor information gathered from the user.

At block 503, method 500 provides directing the USB data switch to open which blocks an exchange of the second USB data between the sensor hub and the USB hub. This may block the exchange to the private sensor data from both being transmitted to the host device, as well as blocking the sensors from receiving data from the host device. In some scenarios, the sensors may also be instructed to stop capturing user data in response to it being determined that the transmission of the user data is not authorized.

Still referring to FIG. 5, method 500 further includes, receiving third USB data from the USB hub, at block 504. At block 505, method 500 provides identifying another token which indicates that fourth USB data is not private or is authorized for transmission. The new USB data may be continually monitored for a token. Method 500 provides, at block 506, directing the USB data switch to close which allows the exchange of the fourth USB data between the sensor hub and the USB hub.

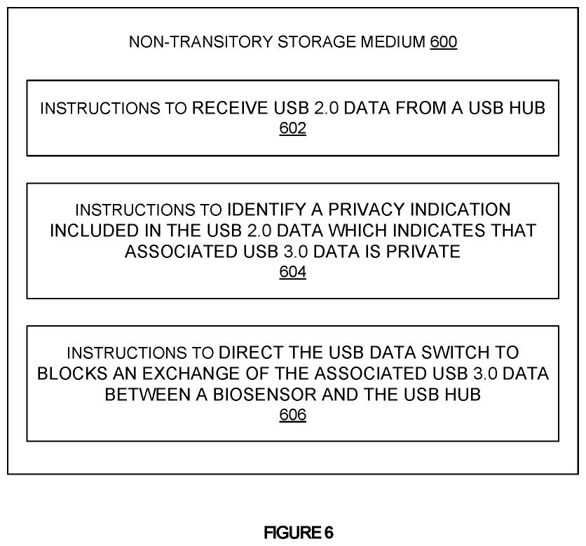

FIG. 6 illustrates a block diagram of a non-transitory readable medium storing machine-readable that upon execution cause a system to direct a USB switch to block the exchange of private data with a host device, according to another example. Storage medium is non-transitory in the sense that is does not encompass a transitory signal but instead is made up of a memory component configured to store the relevant instructions.

The machine-readable instructions include instructions 602 to receive USB 2.0 data from a USB hub. The machine-readable instructions also include instructions 604 to identify a privacy indication included in the USB 2.0 data which indicates that associated USB 3.0 data is private. Furthermore, the machine-readable instructions also include instructions 606 to direct the USB data switch to blocks an exchange of the associated USB 3.0 data between a biosensor and the USB hub.

In one example, program instructions 602-606 can be part of an installation package that when installed can be executed by a processor to implement the components of a computing device. In this case, non-transitory storage medium 600 may be a portable medium such as a CD, DVD, or a flash drive. Non-transitory storage medium 600 may also be maintained by a server from which the installation package can be downloaded and installed. In another example, the program instructions may be part of an application or applications already installed. Here, non-transitory storage medium 600 can include integrated memory, such as a hard drive, solid state drive, and the like.

The functional block diagrams, operational scenarios and sequences, and flow diagrams provided in the Figures are representative of example systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. Those skilled in the art will understand and appreciate that a method could alternatively be represented as a series of interrelated states or events, such as in a state diagram. Moreover, not all acts illustrated in a methodology may be included as a novel example.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

What is claimed is:

1. A head mountable display (HMD) comprising:
an input device to receive captured user data;
a connection interface to exchange the user data with a host device;
a privacy data switch to route the user data between the input device and the connection interface in the HMD; and
a controller to:
determine whether the user data is restricted data;
direct the privacy data switch to block the exchange of the user data when it is determined that the user data is restricted data; and
direct the switch to allow the exchange of the user data when it is determined that the user data is not restricted data.

2. The HMD of claim 1, wherein the switch comprises a universal serial bus (USB) data switch and wherein the controller comprises a microcontroller unit (MCU).

3. The HMD of claim 1, wherein to determine whether the user data is restricted data, the controller continuously monitors for a token associated with the user data which indicates that the associated user data is restricted.

4. The HMD of claim 1, wherein to determine whether the user data is restricted data, the controller detects a first token associated with the user data from the host device which indicates the start of an exchange of restricted data and detects a second token associated with the user data from the host device which indicates the end of the exchange of the restricted data.

5. The HMD of claim 1, wherein:
the restricted data is exchanged with the host device over a universal serial bus (USB) 3.0 connection; and
a token is exchanged with the host device over a USB 2.0 connection.

6. The HMD of claim 1, wherein the controller further directs the sensor to:
stop the capture of the user data when it is determined that the user data is restricted data; and
continue the capture of the user data when it is determined that the user data is not restricted data.

7. The HMD of claim 1, wherein the exchange of the user data comprises the connection interface in the HMD receiving user data from the host device.

8. The HMD of claim 1, wherein the exchange of the user data comprises the connection interface in the HMD to transfer the user data to the host device.

9. The HMD of claim 1, wherein the input device receives the captured user data from a sensor and wherein the user data comprises biological data captured by the sensor.

10. The HMD of claim 1, wherein the input device receives the captured user data from a camera and wherein the user data comprises image data captured by the camera.

11. The HMD of claim 1, wherein the input device receives the captured user data from a microphone and wherein the user data comprises voice data captured by the microphone.

12. A head mountable device (HMD) system comprising:
a universal serial bus (USB) hub to receive first USB data and second USB data from an external computing device;
a USB data switch to exchange the second USB data between the USB hub and a sensor hub of the HMD system; and
a microcontroller unit (MCU) to:
receive the first USB data from the USB hub;
identify a token included in the first USB data which indicates that the transmission of the second USB data is unauthorized; and
direct the USB data switch to open which blocks an exchange of the second USB data between the sensor hub and the USB hub.

13. The HMD system of claim 12, wherein:
the USB hub receives third USB data and fourth USB data from the external computing device; and
the MCU:
receives the third USB data from the USB hub;
identifies another token which indicates that the transmission of the fourth USB data is authorized; and
directs the USB data switch to close which allows the exchange of the fourth USB data between the sensor hub and the USB hub.

14. The HMD system of claim 12, wherein the MCU further directs the USB data switch to transfer an instruction to the sensor data hub to stop the capture of user data in response to the identified token included in the first USB data.

15. A non-transitory computer-readable medium comprising a set of instructions that when executed by a processor, cause the processor to:
receive universal serial bus (USB) 2.0 data from a USB hub;
identify a privacy indication included in the USB 2.0 data which indicates that associated USB 3.0 data is private; and
direct the USB data switch to blocks an exchange of the associated USB 3.0 data between a biosensor and the USB hub.
